(19) United States
(12) Patent Application Publication
(10) Pub. No.: US 2012/0217389 A1
(43) Pub. Date: Aug. 30, 2012

(54) ELECTROSPRAY IONIZATION FOR CHEMICAL ANALYSIS OF ORGANIC MOLECULES FOR MASS SPECTROMETRY

(76) Inventors: Yun Zheng, Rockville, MD (US); Stephanie A. Getty, Washington, DC (US); David E. Franz, Pasadena, MD (US)

(21) Appl. No.: 13/034,125

(22) Filed: Feb. 24, 2011

(51) Int. Cl. H01J 49/10

(52) U.S. Cl. 250/288

(57) ABSTRACT

An electrospray ionization laboratory on a chip for in situ detection of organic molecules includes a substrate, an input for accepting organic molecule samples, an enrichment column for concentrating organic molecule samples and delivering a concentrated sample to a micro fluidic channel, an analytical column connected in serial to the enrichment column for accepting the concentrated sample, a detector for accepting a pressurized fluid output from the analytical column, and an output nozzle assembly for generating an electrospray output for mass spectrometry analysis. The nozzle assembly may include 1, 2 or 4 (arranged in a rectangular fashion) nozzles.

### PRIORITY CLAIM

This application claims priority under 35 U.S.C. §119 to U.S. Provisional Application Ser. No. 61/301,975 entitled “ELECTROSPRAY IONIZATION FOR CHEMICAL ANALYSIS OF ORGANIC MOLECULES FOR MASS SPECTROMETRY” filed on Feb. 25, 2010, the entire contents of which are hereby incorporated by reference.

### ORIGIN OF THE INVENTION

The invention described herein was made by employees of the United States Government, and may be manufactured and used by or for the Government for governmental purposes without the payment of any royalties thereon or therefore.

### BACKGROUND OF THE INVENTION

1. Field of the Invention

This application relates to electrospray ionization equipment for chemical analysis, and in particular, to reduced size electrospray ionization equipment for chemical analysis.

2. Background

Electrospray ionization is preferred to other types of ionization for analysis of large organic molecules due to its soft ionization characteristics and preservation of molecular structure for mass spectrometer analysis.

Liquid chromatography-mass spectrometry (LC-MS) is an analytical chemistry technique that combines the physical separation capabilities of liquid chromatography with the mass analysis capabilities of mass spectrometry. LC-MS is a powerful technique used for many applications which has very high sensitivity and selectivity. Generally its application is oriented towards the specific detection and potential identification of chemicals in the presence of other chemicals in a complex mixture.

Similar to gas chromatography MS (GC-MS), liquid chromatography mass spectrometry separates compounds chromatographically before they are introduced to the ion source and mass spectrometer. It differs from GC-MS in that the mobile phase is liquid, usually a mixture of water and organic solvents, instead of gas and the ions fragments cannot yield predictable patterns. Most commonly, an electrospray ionization source is used in LC/MS.

A difference between traditional high performance liquid chromatography (HPLC) and the chromatography used in LC-MS is that in the latter case the scale is usually much smaller, both with respect to the internal diameter of the column and even more so with respect to flow rate since it scales as the square of the diameter. For a long time, 1 mm columns were typical for LC-MS work. More recently 300 μm and even 75 μm capillary columns have become more prevalent.

A commercial liquid chromatography-mass spectrometry is very big and heavy. Its electrospray ionization nozzle is also a complicated capillary tube, which need a precise mechanical fixture to hold it. It also needs nitrogen gas to facilitate electrospray ionization. They cannot integrate in lab-on-a-chip equipment for in situ analysis such as in a space based mission.

Thus, it may be beneficial to provide a reduced size nozzle for electrospray ionization and other equipment which overcomes these and other problems.

### BRIEF SUMMARY

An Electrospray Ionization (ESI) system is an important component of an advanced liquid chromatography-mass spectrometry instrument for in situ detection of organic molecules. To analyze solvent-extracted sample by liquid chromatography (LC) is an excellent method to keep the integrity of the molecular structure of complex organics. Electrospray ionization (ESI) is preferred to other types of ionization for analysis of large organic molecules due to its soft ionization characteristics and preservation of molecular structure for mass spectrometer analysis.

NASA is developing lab-on-a-chip liquid chromatography for in situ liquid analysis and a minimized time-of-flight mass spectrometer. The MEMS fabricated electrospray ionization chip is a component for these instruments. For NASA flight missions, the liquid chromatography-mass spectrometer is miniaturized as well as the electrospray ionization nozzle. For NASA's lab-on-a-chip liquid chromatography for in situ analysis, the electrospray ionization is integrated in the chip.

A MEMS fabricated ESI chip is integrated with microfluidic sample analysis and handling devices. It is a component for a lab-on-a-chip liquid chromatography for in situ liquid analysis.

An electrospray ionization laboratory on a chip for in situ detection of organic molecules includes a substrate, an input for accepting organic molecule samples, an enrichment column for concentrating organic molecule samples and delivering a concentrated sample to a micro fluidic channel, an analytical column connected in serial to the enrichment column for accepting the concentrated sample, a detector for accepting a pressurized fluid output from the analytical column, and an output nozzle for generating an electrospray output for mass spectrometry analysis.

An electrospray ionization laboratory includes the output nozzle deposited in a cylindrical arrangement perpendicular to the substrate with a first layer cathode with a gap for accepting pressurized fluid output passed through the detector from the analytical column, a second layer isolator bonded adjacent to said cathode for unobstructed fluid flow and a third layer anode for output of electrospray output.

### BRIEF DESCRIPTION OF THE DRAWINGS

FIG. 1 is a block diagram of the micro-fluidic-chip element of an Electrospray Ionization (ESI) device, according to an example embodiment;

FIG. 2 shows the fabrication sequence for the ESI source nozzle, according to an example embodiment;

FIG. 3a is a front view of an embodiment of the ESI nozzle, according to an example embodiment;

FIG. 3b is a side view of the ESI nozzle, according to an example embodiment;

FIG. 4a shows four nozzles arranged in a rectangular or square pattern, according to an example embodiment;

FIG. 4b shows 2 nozzles arranged side by side, according to an example embodiment;

FIG. 4c shows a single nozzle, according to an example embodiment;

FIG. 5a shows four nozzles arranged in a rectangular or square pattern from a scanning electron microscope, according to an example embodiment;

FIG. 5b shows 2 nozzles from a scanning electron microscope, according to an example embodiment;

FIG. 5c shows a single nozzle from a scanning electron microscope, according to an example embodiment;

FIG. 6 shows a graph of the performance of a 20 μm nozzle hole.

### DETAILED DESCRIPTION

Detailed illustrative embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Hereinafter, example embodiments will be described with reference to the attached drawings.

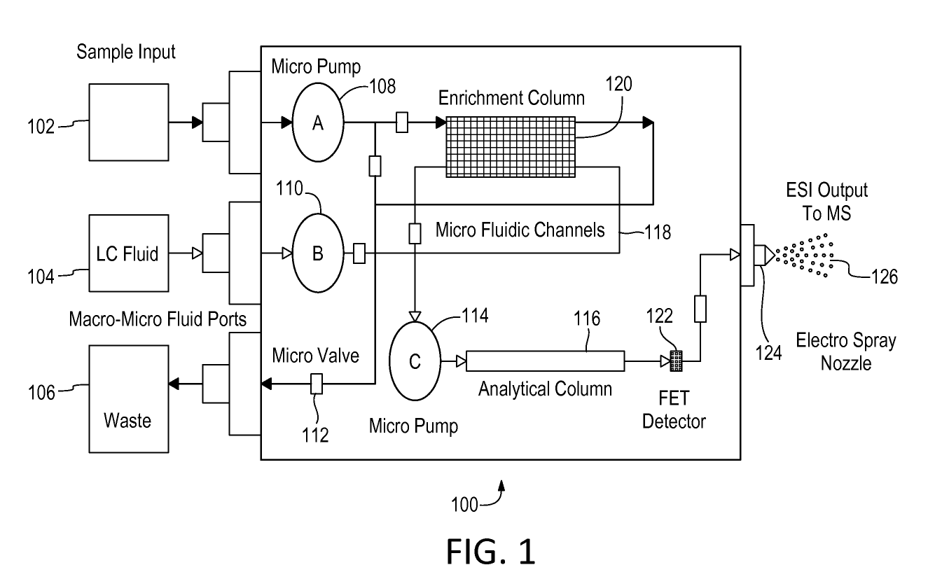

FIG. 1 is a block diagram of the micro-fluidic-chip element of an Electrospray Ionization (ESI) device, a critical component of an advanced liquid chromatography-mass spectrometry instrument for in situ detection of organic molecules that may reveal past or present life. The microfluidic approach greatly improves the capability to analyze complex organics. This technology development, if integrated into the Sample Analysis on Mars (SAM) instrument to be flown on the future Mars Science Laboratory would improve the performance of the instrument. The (SAM) instrument will be able to process solid samples by pyrolysis and evaluate the products by gas chromatography and mass spectrometry. Many of the biological molecules that may be present on Mars are likely to be compromised by high-temperature treatment. To analyze solvent-extracted sample by liquid chromatography (LC) is an excellent method to keep the integrity of the molecular structure of complex organics.

Electrospray ionization (ESI) is preferred to other types of ionization for analysis of large organic molecules due to its “soft” ionization characteristics and preservation of molecular structure for mass spectrometer analysis. Electrospray ionization is a part of in situ liquid sample analysis in a Mars Prospector Rover or Network Lander mission to Mars, future Titan or Europa flagship mission, or any New Frontiers or Discovery Program missions that emphasize the search for biologically relevant organic molecules.

The ESI device of FIG. 1. ingests a sample input 102 combined with LC fluid 104 before being pumped by micro pumps 108,110 into enrichment column 120 before being pumped by micro pump 114 into analytical column 116. The output from analytical column 116 is sent to detector 122 before being sent to electrospray nozzle 124. ESI output 126 is then ready for Mass Spectrometry (MS) Analysis as chromatographically separated fluid for electrospray ionization that is directed to a time-of-flight mass spectrometer. More simply put, a sample liquid is pushed through a very small, charged capillary. The analyte is dissolved in a large amount of solvent and buffers are often added until the analyte exists as an ion in solution. Because like charges repel, the liquid pushes itself out of the capillary and forms an aerosol of 10 μm droplets. The analyte molecules are forced close together as the solvent evaporates. The molecules repel each other and break up the droplets until the analyte is free of solvent. The lone ions are then picked up by the mass spectrometer.

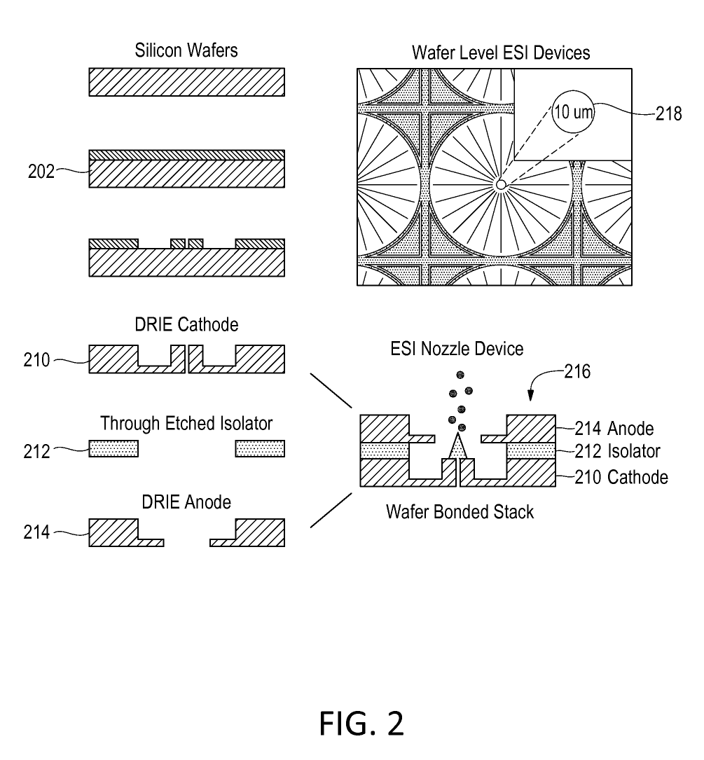

FIG. 2 shows the fabrication sequence for the ESI source using standard MEMS processes and equipment. The ESI nozzle device 216 is formed on silicon layers 202 that are sequentially etched and deposited starting with a deep reactive ion etching (DRIE) technique to form a cathode 210 stacked with an isolator 212 with a DRIE anode 214 on top. The resultant wafer bonded stack 216 acts as the ESI nozzle device with a 10 μm nozzle diameter 218. Pressurized fluid is handled with submicron filtering to prevent clogging. The cathode 210 has a physical gap in its middle allowing pressurized fluid to approach a nozzle formed on the chip substrate.

FIG. 2. shows a conical nozzle, but cylindrical nozzles are also included.

State of the art MEMS fabrication equipment includes isolator growing on the single crystal silicon wafer, photolithographic patterning, wet chemical etching, deep reactive ion etching and bonding of anode, isolator and cathode layers.

Nitrogen nozzles are used in the ESI to infuse nitrogen gas to help nebulizer the liquid from the LC and evaporate solvent to impart a charge on the analyte by addition (ES+ mode, M+H⁺) or removal (ES− mode M−H⁺) of a hydrogen ion with extremely low fragmentation of the parent ion (M).

The most common techniques for analyses of carbonaceous meteorites are reverse phase liquid chromatography with UV fluorescence detection (LC-FD) and gas chromatography-mass spectrometry (GC-MS). Although these analytical techniques have been very useful for the characterization of complex amino acid mixtures found in carbonaceous meteorites, both techniques have their limitations compared to other soft ionization liquid chromatography-mass spectrometry (LC-MS) techniques. GC-MS is unable to characterize polar or charged compounds without chemical derivitization. Polar compounds are of the greatest astrobiological interest since most biologically relevant compounds are polar and of low volatitly, such as amino acids, carboxylic acids, nucleobases, and sugars. All of these compounds perform exceptionally well with ESI methods. Besides the above advantages, solvent extraction coupled with liquid chromatography ESI-TOF-MS, enables extraction of key biomolecules of interest (e.g. amino acids, nucleobases, etc.) that are destroyed during traditional extraction methods such as pyrolysis alone.

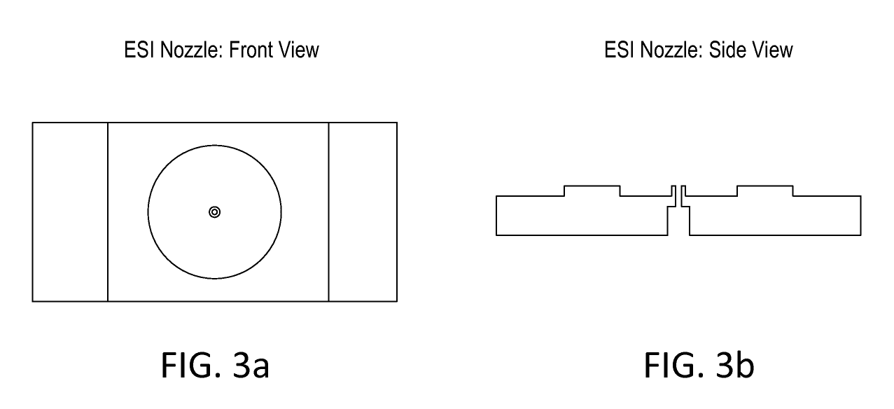

FIG. 3a shows a front view of an embodiment of the ESI nozzle. FIG. 3b shows a side view of the ESI nozzle. The ESI nozzle size is approximately 10 mm by 5 mm and is fabricated in a similar fashion to that describing FIG. 2. Note that FIG. 3b shows a two dimensional view of a cylindrical nozzle.

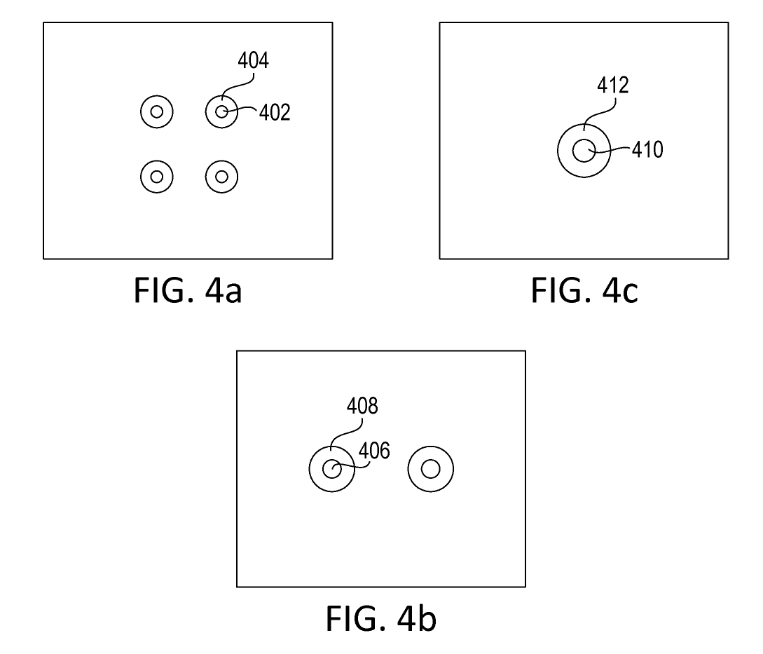

FIGS. 4a-c show optical microscope images of ESI nozzles in various embodiments of the invention. FIG. 4a shows four nozzles arranged in a rectangular or square pattern perpendicular to the substrate. Hole 402 may range in diameter from 5 μm to 20 μm and wall thickness 404 may range from 10 to 15 μm.

FIG. 4b shows 2 nozzles arranged side by side perpendicular to the substrate. Likewise, hole 406 may range in diameter from 5 μm to 20 μm and wall thickness 408 may range from 10 to 15 μm.

FIG. 4c shows a single nozzle arranged perpendicular to the substrate. Hole 410 may range in diameter from 5 μm to 20 μm and wall thickness 412 may range from 10 to 15 μm.

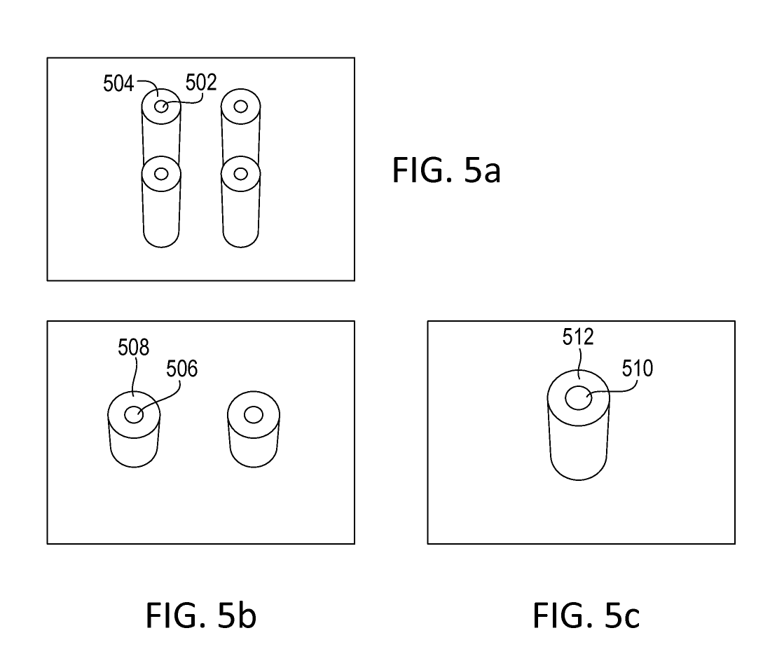

FIGS. 5a-c show electron microscope images tilted at an angle of view of ESI nozzles in various embodiments of the invention. FIG. 5a shows four nozzles arranged in a rectangular or square pattern perpendicular to the substrate. Hole 502 may range in diameter from 5 μm to 20 μm and wall thickness 504 may range from 10 to 15 μm.

FIG. 5b shows 2 nozzles arranged side by side perpendicular to the substrate. Likewise, hole 506 may range in diameter from 5 μm to 20 μm and wall thickness 508 may range from 10 to 15 μm.

FIG. 5c shows a single nozzle arranged perpendicular to the substrate. Hole 510 may range in diameter from 5 μm to 20 μm and wall thickness 512 may range from 10 to 15 μm. Height of the nozzle is up to approximately 150 μm.

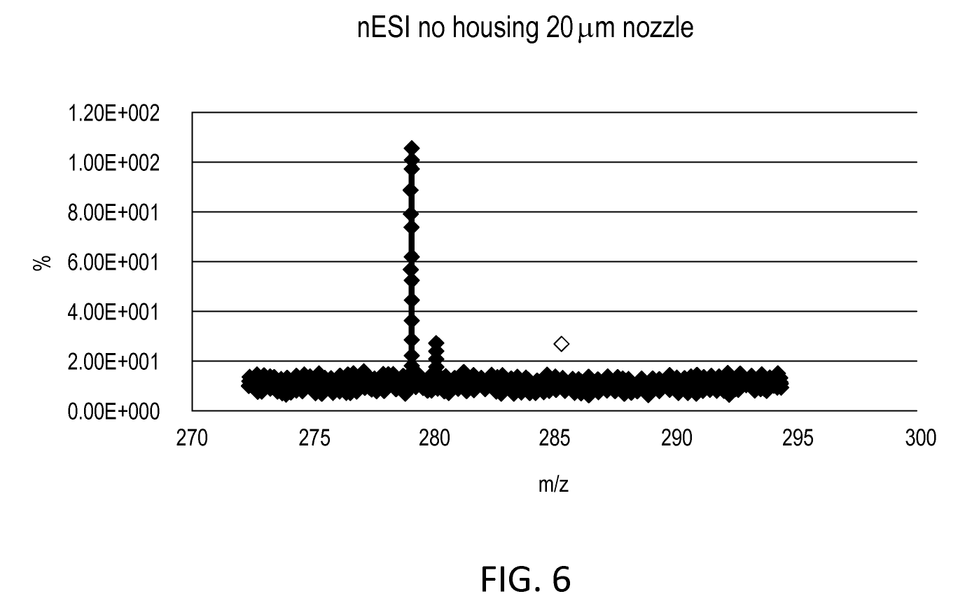

FIG. 6 shows a graph of the performance of a 20 μm nozzle hole. The spectrum is shown with the mass-to-charge (m/z) ratio on the x-axis, and the relative intensity (%) of each peak shown on the y-axis. The peak at approximately 278 m/z shows solid 100% electrospray performance.

The multi-nozzle will increase the efficiency of electro-spray (improve performance) for a multichannel ESI array for the militarized time of flight mass spectrometer (TOF-MS). This is true throughout all designs.

As discussed above, example embodiments of the present invention are directed to Electrospray ionization nozzles. The nozzles provide for a smaller ESI platform capable of exploring other planets without the drawbacks of the conventional art. Further, given the portability described, example embodiments also provide capability for transportable systems here on earth.

Example embodiments include portable chemical and biohazard detection that could be used in airports, ports of entry, buildings or any other similar environment.

The new designed and developed electrospray ionization nozzle is targeted to miniaturized liquid chromatography-mass spectrometry for NASA flight missions. It is made by MEMS technology on a silicon wafer. In our design, the nozzle column is perpendicular to the chip surface, which is different from regular MEMS electrospray ionization nozzle. One feature of our MEMS vertical nozzle is it may integrated into the miniaturized TOF mass spectrometer due to its orientation. It also may be integrated into a microfluidic system, such as lab-on-a-chip device for in situ analysis of organics. The vertical electrospray ionization nozzle can be made by using photolithography patterning and deep reactive ion etching. The processing parameter may be optimized to obtain a straight and smooth hole and column. The fabricated electrospray ionization nozzle holes range from 5 micron to 20 micron. The different nozzle hole size can be used according to microfluidic pressure and flow rate in order to obtain optimized performance

While the invention is described with reference to an exemplary embodiment, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited the embodiments disclosed for carrying out this invention, but that the invention includes all embodiments falling with the scope of the appended claims. Moreover, the use of the terms first, second, etc. does not denote any order of importance, but rather the terms first, second, etc. are used to distinguish one element from another.

What is claimed is:

1. An electrospray ionization laboratory on a chip for in situ detection of organic molecules comprising:
a substrate;
an input for accepting organic molecule samples;
an enrichment column operably connected to said input for concentrating organic molecule samples and delivering a concentrated sample to a micro fluidic channel;
an analytical column operably connected in serial to said enrichment column via said micro fluidic channel for accepting the concentrated sample;
a detector for accepting a pressurized fluid output from the analytical column;
an output nozzle assembly for generating an electrospray output for mass spectrometry analysis, the output nozzle assembly deposited in a cylindrical arrangement perpendicular to said substrate further including:
a first layer cathode with a gap for accepting pressurized fluid output passed through the detector from the analytical column;
a second layer isolator bonded adjacent to said cathode for unobstructed fluid flow; and
a third layer anode for output of electrospray output.

2. The electrospray ionization laboratory on a chip of claim 1, wherein said first second and third layers are part of a wafer bonded stack.

3. The electrospray ionization laboratory on a chip of claim 2, wherein said first layer cathode is a deep reactive ion etching layer.

4. The electrospray ionization laboratory on a chip of claim 3, wherein said second layer isolator is through etched.

5. The electrospray ionization laboratory on a chip of claim 4, wherein said third layer anode is a deep reactive ion etching layer.

6. The electrospray ionization laboratory on a chip of claim 5, wherein said gap is a hole in said cylindrical arrangement of diameter between approximately 5 and 20 μm.

7. The electrospray ionization laboratory on a chip of claim 6, wherein said cylindrical arrangement has a wall thickness of between approximately 10 to 15 μm.

8. The electrospray ionization laboratory on a chip of claim 7, wherein said cylindrical arrangement has a height of up to approximately 150 μm.

9. The electrospray ionization laboratory on a chip of claim 8, wherein said nozzle assembly is single nozzle.

10. The electrospray ionization laboratory on a chip of claim 8, wherein said nozzle assembly is dual nozzle.

11. The electrospray ionization laboratory on a chip of claim 8, wherein said nozzle assembly is quadruple nozzle arranged in a rectangular fashion.

12. A nozzle assembly for use with an electrospray ionization laboratory on a chip for in situ detection of organic molecules with a substrate, an input for accepting organic molecule samples, an enrichment column operably connected to the input for concentrating organic molecule samples and delivering a concentrated sample to a micro fluidic channel, an analytical column operably connected in serial to the enrichment column via the micro fluidic channel for accepting the concentrated sample, a detector for accepting a pressurized fluid output from the analytical column;
the output nozzle assembly for generating an electrospray output for mass spectrometry analysis comprising:
a cylindrical arrangement perpendicular to the substrate further including:
a first layer cathode with a gap for accepting pressurized fluid output passed through the detector from the analytical column;
a second layer isolator bonded adjacent to said cathode for unobstructed fluid flow; and
a third layer anode for output of electrospray output.

13. The nozzle assembly for use with an electrospray ionization laboratory on a chip of claim 12, wherein said first second and third layers are part of a wafer bonded stack.

14. The nozzle assembly for use with an electrospray ionization laboratory on a chip of claim 13, wherein said first layer cathode is a deep reactive ion etching layer.

15. The nozzle assembly for use with an electrospray ionization laboratory on a chip of claim 14, wherein said second layer isolator is through etched.

16. The nozzle assembly for use with an electrospray ionization laboratory on a chip of claim 15, wherein said third layer anode is a deep reactive ion etching layer.

17. The nozzle assembly for use with an electrospray ionization laboratory on a chip of claim 16, wherein said gap is a hole in said cylindrical arrangement of diameter between approximately 5 and 20 μm.

18. The nozzle assembly for use with an electrospray ionization laboratory on a chip of claim 17, wherein said cylindrical arrangement has a wall thickness of between approximately 10 to 15 μm.

19. The nozzle assembly for use with an electrospray ionization laboratory on a chip of claim 18, wherein said cylindrical arrangement has a height of up to approximately 150 μm.

20. The nozzle assembly for use with an electrospray ionization laboratory on a chip of claim 19, wherein said nozzle assembly is single nozzle.

21. The nozzle assembly for use with an electrospray ionization laboratory on a chip of claim 19, wherein said nozzle assembly is dual nozzle.

22. The nozzle assembly for use with an electrospray ionization laboratory on a chip of claim 19, wherein said nozzle assembly is quadruple nozzle arranged in a rectangular fashion.
